(19) United States
(12) Patent Application Publication
(10) Pub. No.: US 2016/0092665 A1
(43) Pub. Date: Mar. 31, 2016

(54) Liveness Detection for User Authentication

(71) Applicant: Intel Corporation, Santa Clara, CA (US)

(72) Inventors: Melissa A. Cowan, Hillsboro, OR (US); Ramune Nagisetty, Portland, OR (US); Jason Martin, Beaverton, OR (US); Richard A. Forand, Portland, OR (US); Conor P. Cahill, Waterford, VA (US); Bradley A. Jackson, Hillsboro, OR (US)

(21) Appl. No.: 14/499,138

(22) Filed: Sep. 27, 2014

(51) Int. Cl. G06F 21/34; G06F 21/35

(52) U.S. Cl. CPC G06F 21/34; G06F 21/35

(57) ABSTRACT

An initial authentication of a user, if successful, causes a token to be stored on, and presented from, a wearable device (WD). The WD continually monitors one or more of the wearer's vital signs to confirm that (1) the WD is being worn by a living person rather than an inanimate simulacrum, and (2) the WD is still worn by the same person who underwent the authentication. The token can be read by a token-reader on at least one protected device (PD). If the token is valid, its presentation serves as authentication and the token-reader grants the user access to the PD. If the WD vital-sign signal is interrupted when the user removes the WD, the WD stops presenting the token and can no longer be used to access a PD.

### FIELD

Related fields include wearable electronics, monitoring of vital signs, and security, particularly continuous or periodic automated verification of a user's authentication.

### BRIEF DESCRIPTION OF DRAWINGS

FIGS. 1A-G illustrate examples of wearable devices.

FIG. 2 is a block diagram of a wearable device (WD) equipped to present (transmit, emit, display, or the like) a token on the condition that the same person has worn the WD since the WD received the token.

FIG. 3A illustrates an example WD with a liveness detector.

FIG. 3B is a conceptual example of a liveness signal collected by a sensor.

FIG. 4 is a flow chart of an example process for initial authentication of a user wearing the WD.

FIGS. 5A-C are block diagrams of examples of an authenticator, a protected device, and a storage module connected to both of them.

FIGS. 6A-B conceptually illustrate the effect of distance sensitivity in embodiments of token-reading protected devices (PDs) and WDs.

FIG. 7 is a flowchart of an example process for interaction between a WD and a PD equipped with a token-reader and distance sensor.

FIGS. 8A-C conceptually illustrate some possible ways for a WD to present a token.

### DETAILED DESCRIPTION

The following terms have the following meanings for this document's purposes.

Approximate Contact: Direct contact with the skin, or direct contact with clothing covering the skin through which the vital sign may still be monitored, or intermittent contact wherein the periods of non-contact are very short (e.g. less than 10 seconds).

Authentication: Verifying that prospective users are who they claim to be before granting access. Authentications may be strong (biometric, multi-factor), moderate (password, pass-gesture) or weak (badges, cards, etc.)

BTLE: Bluetooth Low Energy: Bluetooth type wireless communication over a range about the same as that of Bluetooth Classic (less than 100 m) while consuming between 1/100 and 1/20 as much energy.

Wirelessly connected: Configured so that a signal transmitted by at least one of the components can be received by at least one of the other components.

DL-L: Digital Leash-Length; a maximum distance between a PD and a WD at which a user wearing the WD is treated as continuing to use the PD.

Interruption (of Approximate Contact): A loss of approximate contact lasting longer than a threshold time.

Liveness: Generic for vital signs associated with a living person such as heartbeat, breathing state, body temperature, skin conductivity, and the like.

Lock: Deny access until unlocked; may or may not include logging out the most recent user.

Multi-factor authentication: establishment of the identity of a prospective user of a PD by at least two factors; factors may be passwords, pass-gestures, answers to security questions, biometric measurements, or any suitable method.

NFC: Near Field Communication; a protocol standard to cause RF communication between devices (usually mobile devices) when they touch each other or are closer together than a few cm.

Operable to: Capable of performing the function described, whether or not originally designed specifically for that function.

Present (a Token): Make the token available, detectable, or readable (generic for transmitting, emitting, displaying, etc.).

Programmable Memory: Memory that can be erased and rewritten many times.

PD: Protected Device; a device configured to restrict access to authorized users.

RF: Radio-frequency; typically 3 kHz to 300 GHz.

RSSI: Received signal strength indication (in arbitrary units). May be used in a wireless environment to determine when the amount of radio energy in a channel is below a certain threshold. For example, RSSI will decrease with distance from the source.

SDR: Software Defined Radio: uses software to perform radio communication functions traditionally performed by hardware which may use an RF front end connected to an A/D converter. General purpose processors do most of the signal processing.

Stop Presenting (a Token): Delete, disable, or otherwise invalidate the token.

Token: An object or signal representing the holder's right to cause a machine to perform a particular operation. Such operations may include unlocking and granting the user access to software on the machine.

Unlock: Grant access; may or may not include logging in an authenticated user.

Wearable Device: A device that can be attached to a user's body or clothing without the user needing to constantly grasp or hold it.

Electronic devices are available in a very wide variety. Some devices are very complex. For the sake of clarity, this Description will omit components or processes that may be included in the device but not necessarily used to practice the subject matter herein.

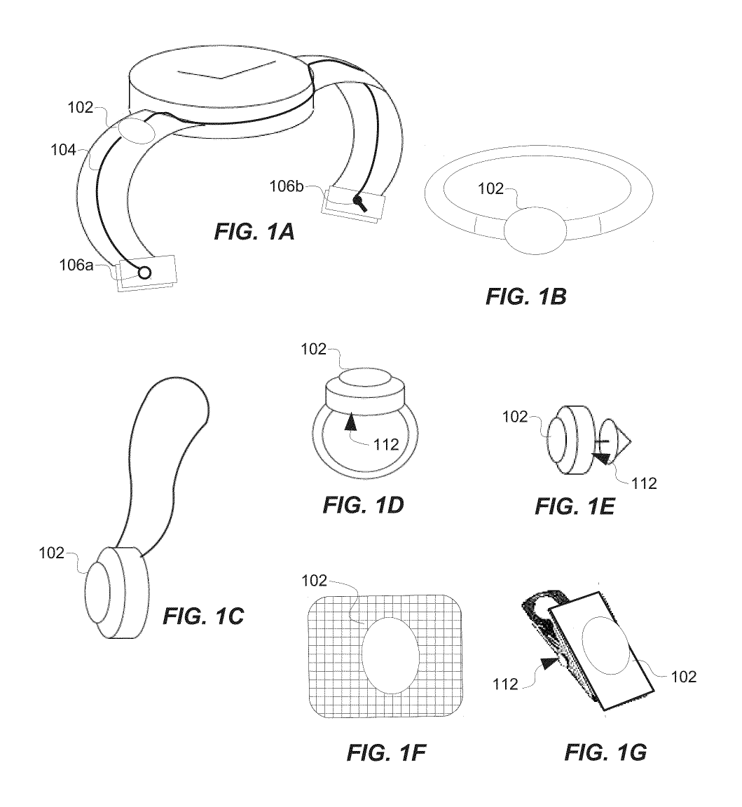

FIGS. 1A-G illustrate examples of wearable devices. Wearable devices may also take a number of other forms besides the watch of FIG. 1A, the wristband of FIG. 1B, the pendant of FIG. 1C, the ring of FIG. 1D, the earring of FIG. 1E, the adhesive patch of FIG. 1F, or the collar or cuff clip of FIG. 1G. For example, one alternative is to build the wearable device into existing apparel or wearable tools, such as safety glasses or goggles, lab coats, gloves, or wireless headsets or earpieces.

If the device has an active transmitting or receiving element, a visible indicator, or display, it may be located in a module 102 on the outside of the wearable article. If the device interacts with the wearer's skin, as in a vital-sign detector or a haptic interface, those components may be located on the skinward side 112 of the wearable article.

In FIG. 1A, the clasp elements 106a and 106b close a circuit 104 that indicates the user's presence. For example, the clasp may enable current to flow, powering a signal transmitter, or the clasped band may affect scanning signals differently than an unclasped band. Separating the clasp elements (or cutting conductor 104) to remove the watch will automatically destroy or invalidate the token.

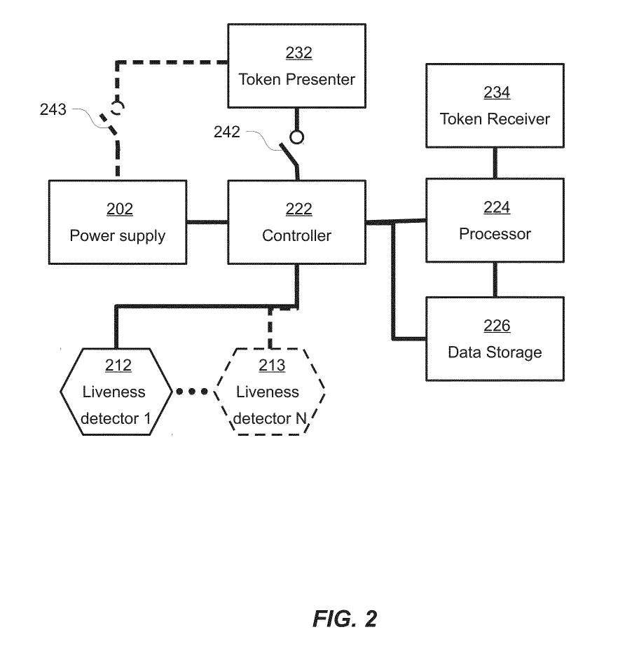

FIG. 2 is a block diagram of a wearable device (WD) equipped to present (transmit, emit, display, or the like) a token on the condition that the same person has worn the WD since the WD received the token. The token information is received at token receiver 234 and passed to processor 224 where, under the control of controller 222, it is processed as needed, stored in data storage 226, and presented by token presenter 232. Data storage 226 may include volatile memory, non-volatile memory, or both.

Token presenter 232 may be a radio transmitter, a light or ultrasound emitter, a display, or any other component that can present a piece of information sufficiently complex to serve the purpose. For example, if a computer or communication station must grant access only to users with a certain security clearance or other authorization, the token may need to be unique to each user and thus fairly complex. If, instead, an alcohol booth at an all-ages festival must serve only those who have shown an ID at the entry gate that proves they are legal drinking age, the token need not be unique to each individual and may be less complex.

To prevent fraudulent use or “spoofing” of tokens, at least one liveness detector 212, and optionally one or more liveness detectors 213, monitor the continued liveness of the user wearing the WD. A vital sign, especially one that varies in a predictable way such as a heartbeat, is more difficult to simulate than mere proximity; in some devices, proximity may be spoofed by covering the proximity sensor(s) with paper, plastic, or the like. Even biometric authenticators may sometimes be fooled by precisely reproduced, or even deceased and detached, body parts of authorized users, but replicating dynamic vital signs in such parts is expected to be challenging.

Controller 222 controls the operation of, and receives the information from, at least one liveness detector 212, and optionally one or more liveness detectors 213. For example, one of the liveness detectors may measure heartbeat or pulse, and another may measure breath, body temperature, or skin conductivity. If there is an interruption in the vital-sign signal, the controller trips a switch 242 (or optional 243) that causes token presenter 232 to immediately stop presenting the token. Therefore, if an unauthorized person takes the WD from its rightful wearer, the vital-sign signal is interrupted during the transfer, automatically causing the token-presenter to stop presenting the token. Without detecting a valid token, none of the protected devices (PDs) requiring a token will unlock. In the festival example, an underage person who acquires an adult's WD will not be able to use it to buy alcohol because, when the adult took off the WD, the interruption in the liveness signal from sensor 212 tripped a control switch 242 or 243, causing the WD to stop presenting the adult's token.

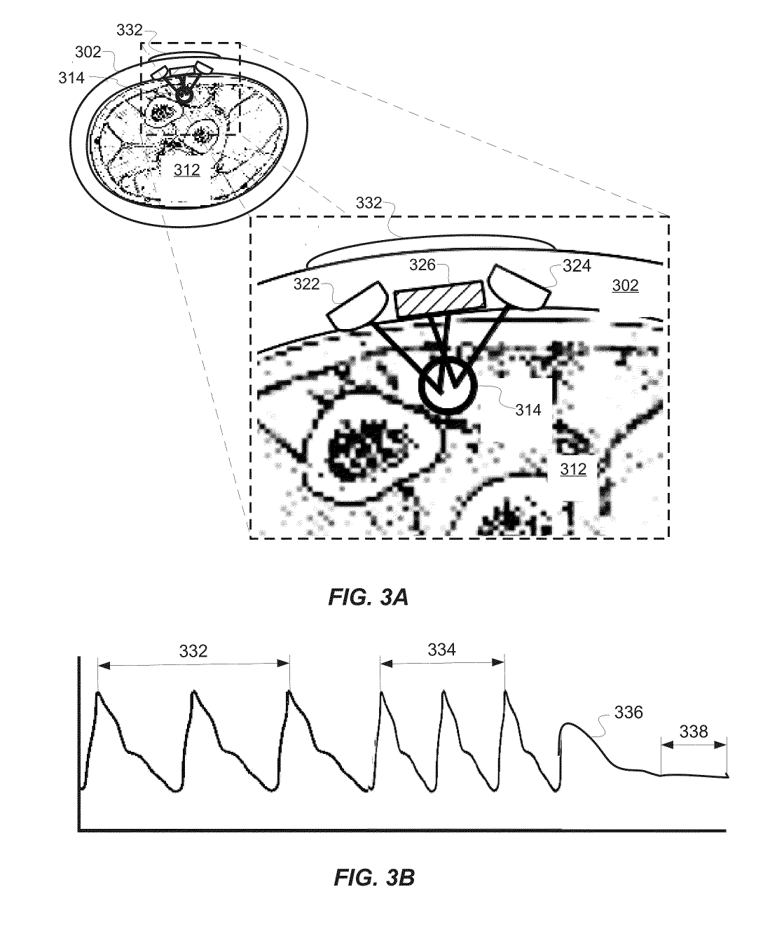

FIG. 3A illustrates an example WD with a liveness detector. The WD shown is a wristband 302. The wrist 312 of the user wearing the WD is shown in cross-section to show the operation of the liveness detector, which is optically tracking the user's pulse through large blood vessel 314 positioned just beneath the thin skin on the inside of the wrist. Components of the WD that need to face outward, such as the token-receiver and the token-presenter, may be housed under outside cover 332.

On the inside surface of wristband 302 adjacent to the user scan, the light sources 322 and 324 illuminate the blood vessel 314. The photodetector 326 detects the reflected and/or scattered light and interior processors and the WD (not shown) track its behavior over time. In some embodiments, light sources 322 and 324 emit at red or infrared wavelengths. These wavelengths are typically transmitted through the skin and the blood vessel wall to be absorbed by hemoglobin cells in the blood. Because the speed of the blood flowing past the illuminated part of the blood vessel varies with a heartbeat, so does the number of hemoglobin cells in the path of light, and thereby the amount of light that is absorbed.

FIG. 3B is a conceptual example of a liveness signal collected by a sensor. While the user wears the WD 302 on wrist 312, the output of photodetector 326 shows a periodic variation. The frequency of the periodic variation may change while the user wears the WD. For example, the heartbeat may have one frequency during a first duration 332 and a different frequency during a second duration 334. An interruption is straightforward to distinguish; flat line 338 may be preceded by some random variations 336. When a heartbeat sensor output behaves randomly or without any significant variation, either the sensor has lost contact with the user's body, the WD has lost power, or the WDs malfunctioning. If, instead of the optical sensors, WD 302 used electrocardiogram electrodes against the user's skin to measure the heartbeat, the results would be analogous.

Some embodiments of WD do not need constant, full contact with the user's skin. The sensors may continue to work acceptably through a layer of clothing were for a small air gap between the sensor and the skin. Likewise, some embodiments may tolerate intermittent separations of short duration by introducing a delay between sensing the interruption and causing the token-presenter to stop presenting the token.

In some embodiments, the WD includes measures to prevent false detection of interruption. If WDs constantly shut themselves off while users were still wearing them, the cost in user time and wear and tear on equipment could increase. Some embodiments may have two or more sensors, either of the same type or different types. Some embodiments may use algorithms to measure the exact timing and behavior of interruption-like events and ignore those that last for less than a threshold duration (e.g. 1 second), such as what happens when a person wearing a pendant walks or leans over to pick something up. The pendant may temporarily lose contact with the skin and come back into contact with a short time. Some embodiments, similarly to the example in FIG. 1A, are removed only by undoing a clasp or cutting a strap; for example, wrist straps too tight to slip over the hand or pendants suspended on straps too short to slip over the head. When the clasp is undone or the strap is cut, a circuit is opened that immediately stops the presentation of the token.

Clearly, this application presents different challenges than the use of liveness detectors for health evaluation. Unlike the health-monitoring type of WD, the processors described here need not necessarily look for problems, store results over very long periods, or compare results with normalized standards. Also unlike health-monitoring WDs, these devices need to recognize and react to interruptions. Some embodiments need to discriminate between an interruption that signifies removal of the device and one that does not. Therefore, an unmodified existing health-monitoring WD might not be satisfactory for this application.

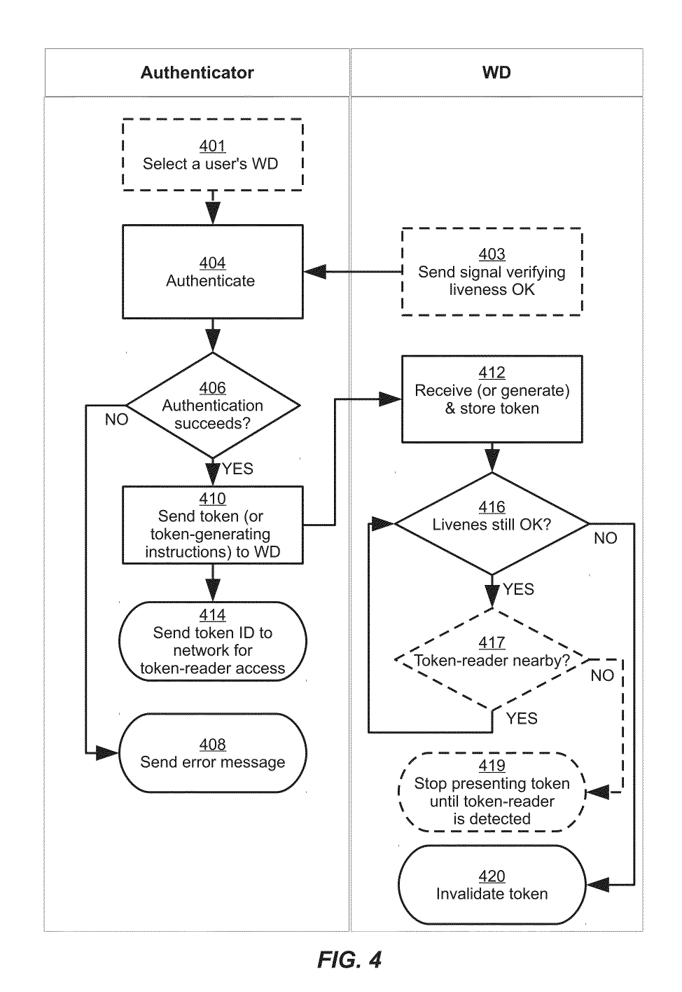

FIG. 4 is a flow chart of an example process for initial authentication of a user wearing the WD. The “Authenticator” is a device external to the WD, configured to perform authentication of users and communicate with the WD. It may be a multi-purpose device with authentication capabilities, such as the user's primary work computer; after authentication, the user may continue working with the same device. Alternatively, the authenticator may be a stand-alone dedicated device (e.g., if the type of authentication desired requires equipment that is expensive or high-maintenance). A prospective user puts on the WD and engages with the authenticator (e.g., pressing a key, touching the screen, or coming within the authenticator sensor range so that the authenticator automatically starts when it senses the WD).

In some embodiments, the authenticator may begin by distinguishing the authenticating user's WD from other WDs that happen to be within authentication range (step 401). This is a precaution against having two or more WDs with the same token in applications where each token needs to be unique. In an environment where additional WDs may or may not be in the range, the system may alert the authenticating user to ask other users to step out of range until the authentication is complete. Alternatively, in a higher-density environment where 2 or more WDs are likely to be within range of the authenticator at any given time, each WD may be associated with a particular authorized user. The association may be set up in the infrastructure or by pairing the WD to a trusted device, e.g., via Bluetooth.

In some embodiments, the WD sends the authenticator a signal verifying that the vital-sign measurements appear acceptable (step 403). This enables the authenticator to sense any possible malfunctions in the WD and warn the user that there may be a problem that needs to be addressed before beginning the authentication (step 404).

If the authentication is unsuccessful, the authenticator displays or otherwise transmits an error message (step 408) and does not send a token to the WD. If the authentication is successful, the authenticator sends a token to the WD's receiver (step 410) and the WD stores the token in memory (step 412). Alternatively, the authenticator may transmit a command for the WD to generate the token using its own processor, and the WD may generate the token and store it in memory. Using either approach, if the tokens need to be unique, a step may be included to check other currently-valid tokens on the network to ensure that no two are the same. Alternatively, a similar type of algorithm may be used to generate the tokens that is used to generate strong passwords; i.e., so many variables are included that duplication is extremely unlikely. In situations where some tokens may be the same, these precautions may not be necessary. Either the authenticator (step 414) or the WD (alternatively) copies the token to the network onto a roster of valid tokens for reference by PDs with token-readers.

During this process, the WD continues monitoring the user's liveness (step 416). If at any time the WD recognizes an interruption signifying that the user has removed the WD, in invalidates the token if present (step 420) or alternatively refuses to accept a token, triggering an error message from the authenticator. If the liveness is uninterrupted, the WD may continuously present the token. Alternatively (e.g., in embodiments where the WD's onboard power must be conserved and presenting the token is a power-hungry process) the WD may scan the environment for a nearby token-reader (step 417) and only present the token when it finds one (step 419).

In some embodiments, liveness is represented by its own token, which operates independently of other tokens. Time-stamps and other metadata may be compared or correlated between the multiple tokens, enabling each token set to enforce multiple policies (e.g., granting or denying access).

The authentication may be single-factor or multi-factor. The multi-factor authentication may use any suitable combination of factors appropriate to the situation. Both biometric and non-biometric factors may be used. Non-limiting examples of biometric factors include face recognition, voice recognition, fingerprint or palm-vein analysis, or various ocular scans. In some embodiments, the user may be offered a choice of biometric measurements in case of temporary problems (fingertip injury, laryngitis, and the like). Non-limiting examples of non-biometric factors include passwords, pass-gestures, and detachable credentials such as smart cards and key fobs. Some factors are less secure than others; the number and choice of factors for each embodiment depends on the security needs and budget of the situation and the tolerance of the user group. In some embodiments, the token may include an attribute of a biometric measurement. In some embodiments where the liveness detection is a separate token, it may be used as an authentication factor.

The token presented by the WD after a successful authentication will grant the user access to one or more PDs (protected devices) as long as the token remains valid. The token only remains valid as long as the user does not remove the WD. Other events that could end the validity include a loss of power to the WD, a malfunction of the WD, or an administrative system-wide reset. For example, administrators of some secure environments may choose to reset the system and require users to re-authenticate every 24 hours. Another option is to require users to re-authenticate if they seek access to a PD outside their normal working hours.

Non-limiting examples of PDs include computers with access to sensitive data; secure communication devices; intelligent electronic locks on doors, cabinets, cases, vehicles, and enclosed compartments containing non-user-serviceable parts of a purchased item. PDs may also be computer-controlled instruments or tools in a laboratory, shop, or factory, where access needs to be restricted to persons trained to operate them correctly and safely. Human-attended cash transfer points, such as cash registers and bank-teller drawers, may also benefit from this type of automated security. In some embodiments, a personal computer may require authentication to use stored credit card numbers for online purchases. Token-presenting wearables may also be issued to hospital patients, individually identified voters, members of a VIP list, or holders of press passes.

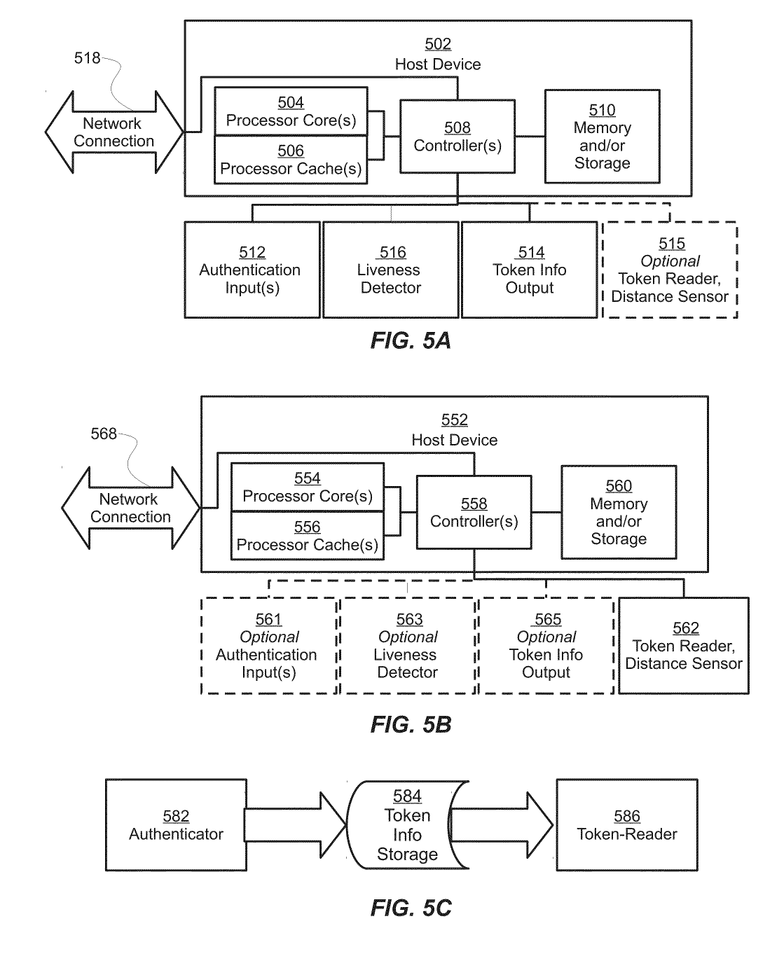

FIGS. 5A-C are block diagrams of examples of an authenticator, a protected device, and a storage module connected to both of them. FIG. 5A shows some components common to some embodiments of authenticators. Host devices 502 can range from dedicated authentication platforms through general purpose computers, tablets, and smart phones. In general, the authenticator has one or more processor cores 504 and accompanying caches 506 where collected authentication data is processed; storage 510 configured to save data and programs; a network connection 518; and a controller 508 controlling their functions.

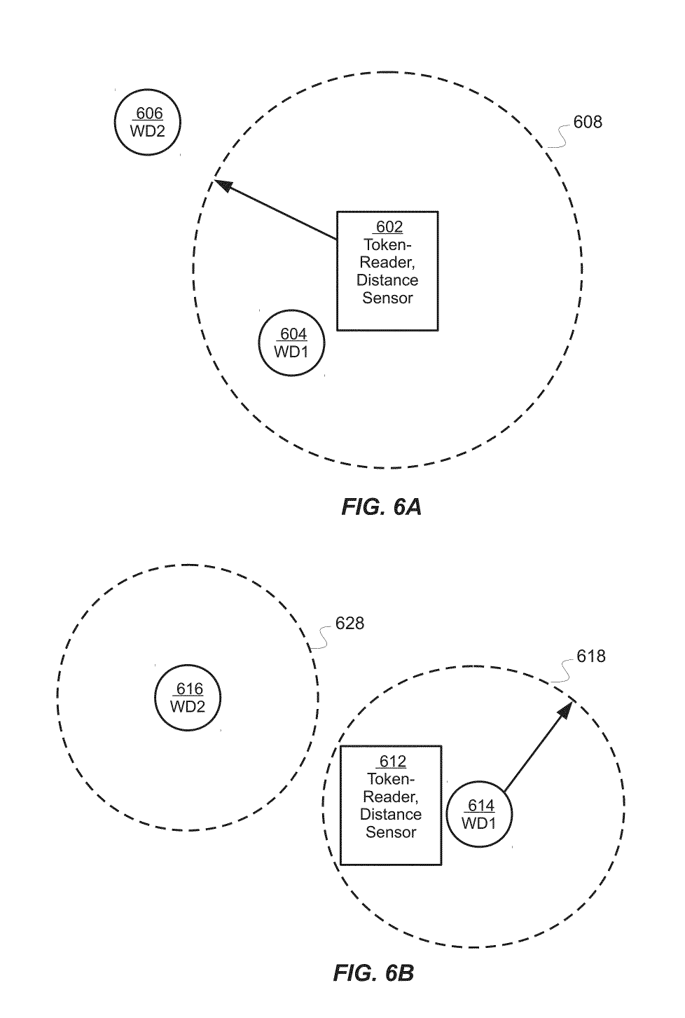

Controller 508 also controls one or more multi-factor authentication inputs 512, such as a keyboard, a mouse, a touchscreen, a camera, a microphone, or a high-resolution scanner. Likewise, controller 508 controls an output 514 to transmit token information (e.g., the actual token, a compressed form of the token to be extracted by the WD, or instructions to the WD on how to generate the token). Optionally, controller 508 may control a WD liveness information receiver 513 which receives communications from the WD, e.g., that the user's liveness measurements are acceptable or that the WD is in good working order. Optionally (for example, if the authenticator host device has other, restricted uses as a PD), host device 502 may also include a token-reader 515 to grant access to previously-authenticated users. Token-reader 515 may include, or be connected to, a distance sensor to enable automatic locking (which will be discussed below with reference to FIG. 6).

FIG. 5B shows some of the components common to some embodiments of PDs. One or more processor cores 554 and caches 556, memory/storage 560, network connection 568, and controller 558 support the functioning of token-reader 562 but may share resources with other functions and components of host device 552. As illustrated, the token-reader and distance sensor are both in module 562, but they may alternatively be located in separate modules of the PD. Optionally, host device 552 may also include authenticator components 561, 563, 565 so that it can both do the initial authentications and subsequently accept the valid tokens to grant access.

FIG. 5C shows authenticator 582 passing token information (e.g., members of a list of the currently valid tokens or criteria defining the currently-valid tokens) to a storage module 584 on a network shared between the authenticator and one or more PDs with token-readers. When the user's WD presents the token to a PD's token-reader 586, the PD may compare the token being presented with the token list or token criteria on storage module 584.

FIGS. 6A-B conceptually illustrate the effect of distance sensitivity in embodiments of token-reading protected devices (PDs) and WDs. While the WD's sensor continues to monitor one or more vital signs to confirm that the original authenticated user is still wearing the WD, the token-reader in the PD at monitors the continued validity of the token after granting access to a user, and a distance sensor associated with the token-reader measures how far the WD, and hence the user, is from the PD. When the authenticated user moves so far away from the PD as to no longer be using it, the distance sensor causes the PD to lock itself as another way to prevent unauthorized access.

In FIG. 6A, the token-reader 602 senses the distance between itself and the user's WD and, if the distance increases beyond a digital leash-length (DL-L) 610, the PD's processor locks the PD, optionally saving all unsaved data and logging out the user. In the illustration, WD1 worn by first user 604 is inside the circle 608 marking the extent of the DL-L of token-reader 602, while WD2 worn by second user 606 is outside the circle 608. The PD attached to token-reader 602 will continue allowing access to user 604 until WD1 moves outside circle 608 (unless WD1 stops presenting the token due to a liveness-signal interruption or power failure).

NFC and SDR are two examples of technologies that provide flexibility in setting the DL-L. In some embodiments, the desired DL-L may only be a few feet, while in others it may be an entire lab or section of factory floor, as when the user's task requires moving back and forth to sequentially use several PDs. The decrease in signal strength (e.g., RSSI) with distance from the source is well characterized for a number of protocols. Therefore, the BTLE RSSI corresponding to the PD's DL-L may be used as a threshold for the log off/locking process. If the WD is presenting the token as a BTLE (or NFC, or other short-range protocol) RF signal, the distance sensor can be integrated with the token-reader.

In some embodiments, the token-reader may scan for other valid tokens within the DL-L after the distance sensor reports that the correct user has moved outside the DL-L. If the token-reader finds another valid token within the DL-L, the associated user may be given the option of keeping the session open. This would allow, for example, lab partners to cover for each other on breaks.

FIG. 6B illustrates an alternative way to activate the token-reader on a PD. Instead of causing the token-reader to constantly scan for valid tokens inside its DL-L, it may go into a sleep mode after a user leaves. The WDs in these embodiments send out a “wake-up” signal to a predetermined radius (e.g., the radius of circle 618 or circle 628). The token-reader only begins to scan for valid tokens upon receiving the wake-up signal at an above-threshold strength representing a distance less than the DL-L.

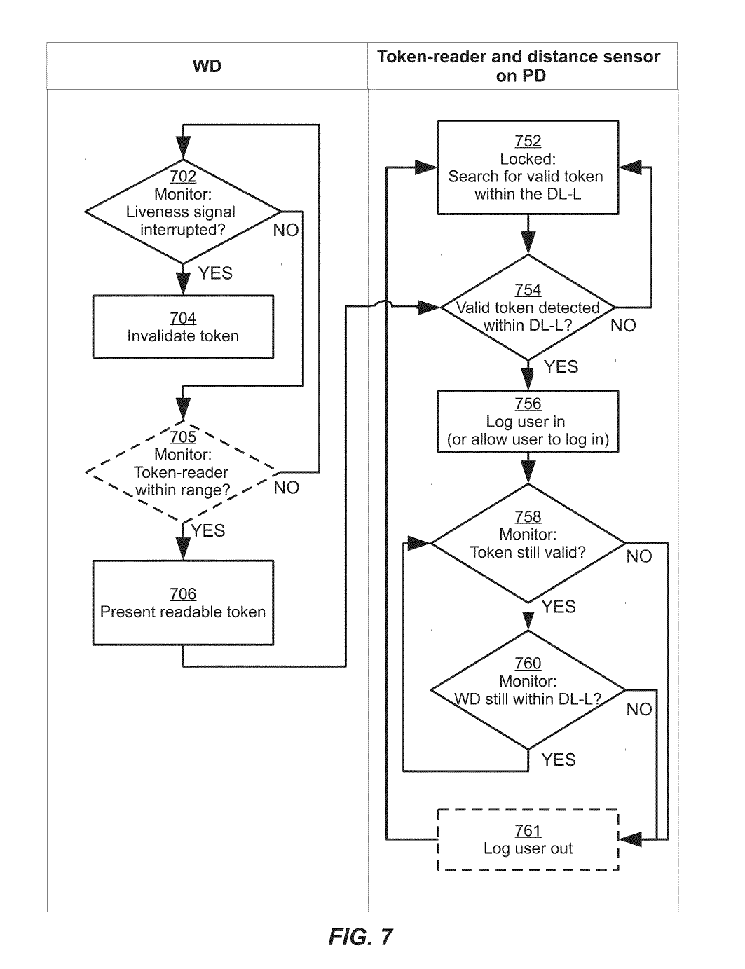

FIG. 7 is a flowchart of an example process for interaction between a WD and a PD equipped with a token-reader and distance sensor. At this point, the user wearing the WD has been authenticated and the WD presents a valid token. The WD continues to monitor one or more vital signs of the user (step 702) and will invalidate or cease to present the token if it detects an interruption to indicate the user has taken off the WD (step 704). Optionally, some embodiments may include the WD monitoring whether a token-reader is within its range (step 705) and expending the energy to present the token only if the token-reader is detected (step 706), while some embodiments skip to step 706 and present the token continuously.

At the beginning the PD is locked, but its token-reader may scan for a valid tokens within the DL-L (step 752) or alternatively the token-reader may be in sleep mode until receiving a wake-up signal from the WD within the DL-L. Upon detecting that a valid token is within the DL-L (step 754), the token-reader unlocks the PD and either automatically logs the user in or permits the user to log him- or herself in (step 756). The token-reader then continuously (or very frequently) monitors the WD to confirm that the token is still valid (step 758), while the associated distance sensor monitors the WD to confirm that the WD is still located within the DL-L (step 760). As long as both conditions are true, the PD allows the user to continue access. If either condition becomes untrue, the PD will go back to a locked state (return to step 752), optionally after logging the user out (step 761) and/or saving any unsaved work.

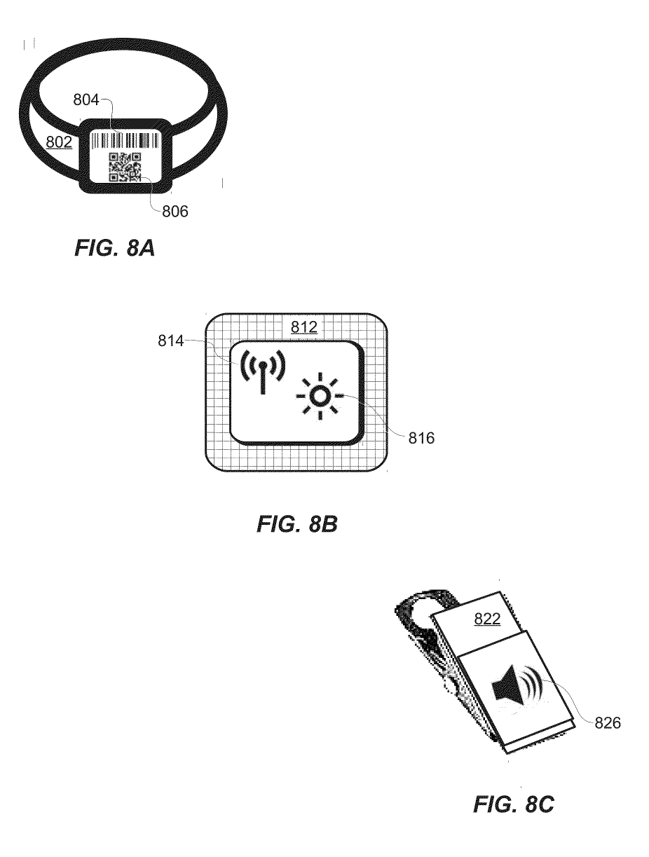

FIGS. 8A-C conceptually illustrate some possible ways for a WD to present a token. Although different types of token are illustrated with different types of WD, any of the token types may be used with any type of WD.

In FIG. 8A, bracelet 802 has a small display screen capable of displaying tokens as patterns such as barcode 804 or QR code 806. The token-reader for these embodiments would capture the image, e.g., with a camera. In some embodiments, the token may be dynamic, periodically changing in a prescribed manner.

In FIG. 8B, adhesive patch 812 emits an electromagnetic token in the form of radio waves 814 or light 816. The token-reader for these embodiments would receive the token through a radio receiver or IR photodetector. In some embodiments, light 816 is infrared and invisible to the unaided human eye. The token may be a particular frequency spectrum or a repeating series of pulses or changing waveforms.

In FIG. 8C, collar-or-cuff clip 822 emits an acoustic token 826, optionally outside the range of human hearing. The corresponding token-reader would receive the signal through a microphone or ultrasonic transducer.

The preceding Description and accompanying Drawings describe example embodiments in some detail to aid understanding. However, the scope of the claims may cover equivalents, permutations, and combinations that are not explicitly described herein.

We claim:

1. A wearable device, comprising:
logic, at least partially comprising hardware logic, to:
receive a token from a remote authenticator;
store the token in a memory;
detect a signal change from a liveness detector corresponding to an interruption of the liveness detector's reception of a vital sign of a user; and
respond to the signal change by preventing presentation of the token to a remote token-reader.

2. The wearable device of claim 1, wherein the remote authenticator transmits the token after a successful authentication of the user.

3. The wearable device of claim 1, wherein the token comprises an electromagnetic signal presented by transmission or emission.

4. The wearable device of claim 1, wherein the token comprises a visible pattern presented by display.

5. The wearable device of claim 1, wherein the token comprises an acoustic signal presented by emission.

6. The wearable device of claim 1, wherein the vital sign comprises at least one of a heartbeat, breathing process, skin conductivity, or generation of body heat.

7. A system, comprising:
an authenticator operable to perform an authentication of a user and to transmit information about a token after completing a successful authentication;
a wearable device worn by the user during and after the authentication, operable to receive the information about the token, generate the token, present the token in a machine-readable form, monitor a vital sign of the user via a liveness detector, and stop presenting the token upon detecting an interruption in the vital sign;
a protected device operable to deny access before receiving an unlock signal and after receiving a lock signal; and
a token-reader wirelessly connected to the protected device and operable to read a token, to determine validity of the token, to send the unlock signal or the lock signal to the protected device;
wherein the token-reader is programmed to send the unlock signal after first detecting a valid token, to monitor the valid token after sending the unlock signal, and to send the lock signal after failing to detect the valid token.

8. The system of claim 7, wherein the authentication comprises a single-factor authentication.

9. The system of claim 7, wherein the authentication comprises a multi-factor authentication.

10. The system of claim 7, wherein the protected device comprises both of the authenticator and the token-reader.

11. The system of claim 7, wherein:
a first device comprises the authenticator;
a second device comprises the token-reader; and
the first device is different from the second device.

12. The system of claim 7, wherein the information about the token comprises the token; and
wherein the token is generated in the wearable device by being received and stored in a memory in the wearable device.

13. The system of claim 7, wherein the information about the token comprises instructions or parameters for generating the token;
wherein the token is generated in the wearable device by being created on the wearable device according to the instructions or parameters received; and
wherein the token is thereafter stored in a memory in the wearable device.

14. The system of claim 7, wherein the unlocking comprises automatically logging in the user.

15. The system of claim 7, wherein the locking comprises automatically logging out the user.

16. The system of claim 7, wherein the token-reader monitors the valid token continuously.

17. The system of claim 7, wherein the token comprises an electromagnetic signal;
wherein the wearable device presents the token by transmitting the electromagnetic signal;
and wherein the token-reader comprises a receiver responsive within the bandwidth of the electromagnetic signal.

18. The system of claim 7, wherein the token comprises a pattern;
wherein the wearable device presents the token by displaying the pattern; and
wherein the token-reader is configured to capture an image of the pattern for analysis.

19. The system of claim 7, wherein the liveness detector presents a separate token, resulting in different token-readers enforcing different policies conditioned on the validity of a subset of a plurality of tokens presented by each user.

20. A non-transitory machine-readable information storage medium programmed with instructions for a machine to perform actions, the actions comprising:
receiving a token from a remote authenticator;
storing the token in a memory;
detecting a signal change from a liveness detector corresponding to an interruption of the liveness detector's reception of a vital sign of a user; and
responding to the signal change by preventing presentation of the token to a remote token-reader.
